(19) United States
(12) Patent Application Publication
(10) Pub. No.: US 2013/0346219 A1
(43) Pub. Date: Dec. 26, 2013

(54) BID ESTIMATION FOR CONTEXTUAL ADVERTISEMENTS

(71) Applicants: Ye Chen, Sunnyvale, CA (US); Pavel Berkhin, Sunnyvale, CA (US); Jie Li, Palo Alto, CA (US); Xia Sharon Wan, Saratoga, CA (US); Tak Yan, Palo Alto, CA (US)

(72) Inventors: Ye Chen, Sunnyvale, CA (US); Pavel Berkhin, Sunnyvale, CA (US); Jie Li, Palo Alto, CA (US); Xia Sharon Wan, Saratoga, CA (US); Tak Yan, Palo Alto, CA (US)

(73) Assignee: MICROSOFT CORPORATION, Redmond, WA (US)

(21) Appl. No.: 13/532,310

(22) Filed: Jun. 25, 2012

(51) Int. Cl. G06Q 30/02

(52) U.S. Cl. 705/14.71

(57) ABSTRACT

Methods and systems for estimating the value of a contextual ad impression are provided. Requests for value-based bids for ad impressions are received from bidders and the value of the ad impression is estimated based primarily upon leveraging sell-side data (user and publisher). The estimation is highly economized through a fast implementation of k-nearest-neighbor (kNN) regression. Embodiments of the present invention further address the cold-start problem or the exploration vs. exploitation requirement by Bayesian (hierarchical) smoothing using a beta prior, and adapt to the temporal dynamics using an autoregressive model to decay importance of certain data.

### BACKGROUND

The process of bidding for an advertisement online involves an ad exchange sending a request for a bid for an advertisement impression to an ad network or more generally, a bidder. The bidder then returns a bid based upon the value of the impression based on what may be considered the revenue opportunity through winning the auction and a user clicking on the served advertisement. Such traditional value-based bid estimation incurs the computational cost-to-bid. The cost-to-bid primarily incurred by bid estimation sinks regardless of whether the bidder wins the auction, and does not depend on the click-through-rate. Hence, it is difficult to justify, under a competitive exchange, low-response impression opportunities. A typical value of a winning rate in an open exchange is 10%, and the value of a click-through-rate for contextual ads can be as low as 0.3%.

Typical approaches to estimating the valuation of an ad impression involve a full-fledged valuation model based on Bayesian profit regression. Such approaches involve the scanning of hundreds of campaigns for a best match to realize the ad impression value. This approach is costly in terms of the cost-to-bid.

### SUMMARY

Embodiments of the present relate to estimating the value of a contextual ad impression. Requests for value-based bids for ad impressions are received from bidders and the value of the ad impression is estimated based primarily upon leveraging sell-side data (user and publisher). The estimation is highly economized through a fast implementation of k-nearest-neighbor (kNN) regression. Embodiments of the present invention further address the cold-start problem or the exploration vs. exploitation requirement by Bayesian (hierarchical) smoothing using a beta prior, and adapt to the temporal dynamics using an autoregressive model to decay importance of certain data.

One of several advantages of the present invention is that a sufficiently accurate value-based bid is provided in a cost-efficient manner to optimize profit or return-on-investment (ROI) for a bidder. This advantage is achieved, in embodiments, by excluding the buy-side data from the determination of the value of the impression, or, in embodiments, relying only on the sell-side data. In embodiments, the value of the impression may be accurately determined with a substantially lower cost-to-bid.

This Summary is provided to introduce a selection of concepts in a simplified form that are further described below in the Detailed Description. This Summary is not intended to identify key features or essential features of the claimed subject matter. Nor is this Summary intended to be used as an aid in determining the scope of the claimed subject matter.

### BRIEF DESCRIPTION OF THE DRAWINGS

Illustrative embodiments of the present invention are described in detail below with reference to the attached drawing figures, and wherein:

FIG. 1 is a block diagram illustrating an exemplary computing environment suitable for implementing embodiments discussed herein;

FIG. 2 is a schematic diagram illustrating a networked environment suitable for implementing embodiments described herein;

FIG. 3 is a flow diagram illustrating an exemplary method for estimating the value of an ad impression, in accordance with an embodiment of the present invention; and

FIG. 4 is a schematic diagram illustrating a static and dynamic prediction vs. actual dollars per thousand impressions, in accordance with an embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable storage media for estimating the value of contextual ad impressions. Requests for value-based bids for ad impressions are received from bidders and the value of the ad impression is estimated based primarily upon leveraging sell-side data (user and publisher). The estimation is highly economized through a fast implementation of k-nearest-neighbor (kNN) regression. Embodiments of the present invention further address the cold-start problem or the exploration vs. exploitation requirement by Bayesian (hierarchical) smoothing using a beta prior, and adapt to the temporal dynamics using an autoregressive model to decay importance of certain data. Embodiments described herein provide an accurate value-based bid to a bidder, ad exchange, or other entity, in a cost-efficient manner to optimize profit or return on investment for an ad network.

Accordingly, one embodiment of the present invention is directed to one or more computer-readable storage media having computer-executable instructions embodied thereon that, when executed, perform a method of estimating value of ad impressions. The method includes receiving a request for a value-based bid for an ad impression from a bidder, estimating the value of the ad impression based upon sell-side data, determining the value-based bid for het ad impression, and providing the value-based bid to the bidder.

In another embodiment, the present invention is directed to a method for estimating the value of an ad impression. The method includes receiving a request for a value-based bid for an ad impression from a bidder and estimating the value of the ad impression based upon sell-side data. The sell-side data may comprise at least one of a user geolocation, a user identification, a site domain associated with a publisher, a publisher page Uniform Resource Locator (URL), and a placement location for the ad. The method further includes determining the value-based bid for the ad impression and providing the bid to the bidder.

In yet another embodiment, the present invention is directed to one or more computer-readable storage media having computer-executable instructions embodied thereon that, when executed, perform a method of estimating value of ad impressions. The method comprises receiving a request for a value-based bid for an ad impression from a bidder and estimating the value of the ad impression based upon sell-side data. The value of the ad impression is estimated utilizing a predictive model of the general form y=f(x), wherein y is the value of the ad impression and x is the sell-side data. The predictive model comprises a k-nearest-neighbor (kNN) regression, hierarchical smoothing and an autoregressive model to decay importance of certain data. The method further comprises determining the value-based bid for the ad impression and providing the value-based bid to the bidder.

One skilled in the art will understand and appreciate that the bidding process for an advertisement online typically includes an ad exchange sending a request for a bid for an ad impression to an ad network or more generally, a bidder. The bidder then returns a bid based upon the value of the impression or what may be considered the revenue opportunity through winning the auction and a user clicking on the served advertisement. The value-based bid estimation incurs the computational cost-to-bid. If the bidder wins the impression, the bidder pays the next highest bid as the traffic acquisition cost. The ad network then runs an internal generalized second-price auction to select which advertisers' advertisements to serve, along with their ranking and pricing, in response to the request for payload from the exchange and incurring the computational cost-to-serve. If the served advertisements are clicked, the advertisers pay the ad network the click-through-rate-adjusted next-highest-cost-per-click bid, as in standard generalized second-price auction pricing. Embodiments described herein generally relate to estimating the impression valuation in response to a request for a bid.

As used herein, the term “ad exchange” refers to a platform that facilitates the bidded buying and selling of online media advertising inventory for multiple ad networks. Examples of ad exchanges include RightMedia, ContextWeb's Exchange, DoubleClick Ad Exchange and AppNexus. As used herein, an “ad network” refers to an online advertising network that connects advertisers to web sites that want to host advertisements. An ad network may be referred to as a “bidder.” In general, the function of the ad network is to aggregate the ad space supply from publishers and match it with the demand of advertisers. As used herein, a “user” is an agent, either a human agent, i.e., end-user, or software agent, who uses a computer or network service. A “publisher,” as the term is utilized herein, is a person or entity that publishes content on a web page and that may desire to monetize such web page by permitting the presentation of advertisements on a portion thereof. The term “sell-side data,” refers to data relevant to the sell-side of an advertising transaction as described herein, that is, to data relevant to the publisher and/or the user. “Sell-side data” includes, but is not limited to, a user geolocation, a page URL, a placement location of an advertisement on a web page, a user identification, and a site domain associated with a publisher. Sell-side data is intended to exclude “buy-side data” which is data relevant not to the user and the publisher but rather to the advertiser.

Acronyms that may be utilized herein include the following:

CTB=Cost-To-Bid,

TAC=Traffic Acquisition,

GSP=Generalized Second-Price Auction,

RFP=Request For Payload,

CTS=Cost-To-Serve,

CTR=Click-Through-Rate, and

CPC=Cost-per-Click.

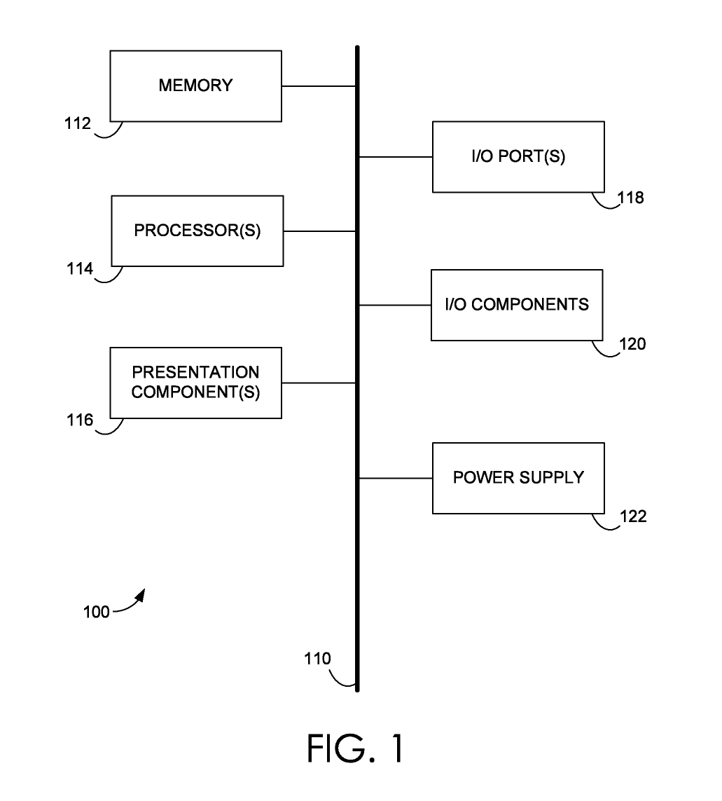

An exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network.

In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

With continued reference to FIG. 1, computing device 100 includes a bus 110 that directly or indirectly couples the following elements: memory 112, one or more processors 114, one or more presentation components 116, input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

The computing device 100 typically includes a variety of computer-readable media. Computer-readable media can be any available media that can be accessed by the computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer storage media in the form of volatile and/or nonvolatile memory. The memory may be removable, non-removable, or a combination thereof. Exemplary hardware devices include solid state memory, hard drives, optical disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, etc.

As previously set forth, embodiments of the present invention relate to systems, methods, and computer-readable storage media for estimating the value of contextual ad impressions. Requests for value-based bids for ad impressions are received from bidders and the value of the ad impression is estimated based primarily upon leveraging sell-side data (user and publisher). The estimation is highly economized through a fast implementation of k-nearest-neighbor (kNN) regression. Embodiments of the present invention further address the cold-start problem or the exploration vs. exploitation requirement by Bayesian (hierarchical) smoothing using a beta prior, and adapt to the temporal dynamics using an autoregressive model to decay importance of certain data. Embodiments described herein provide an accurate value-based bid to a bidder, ad exchange, or other entity, in a cost-efficient manner to optimize profit or return on investment for an ad network.

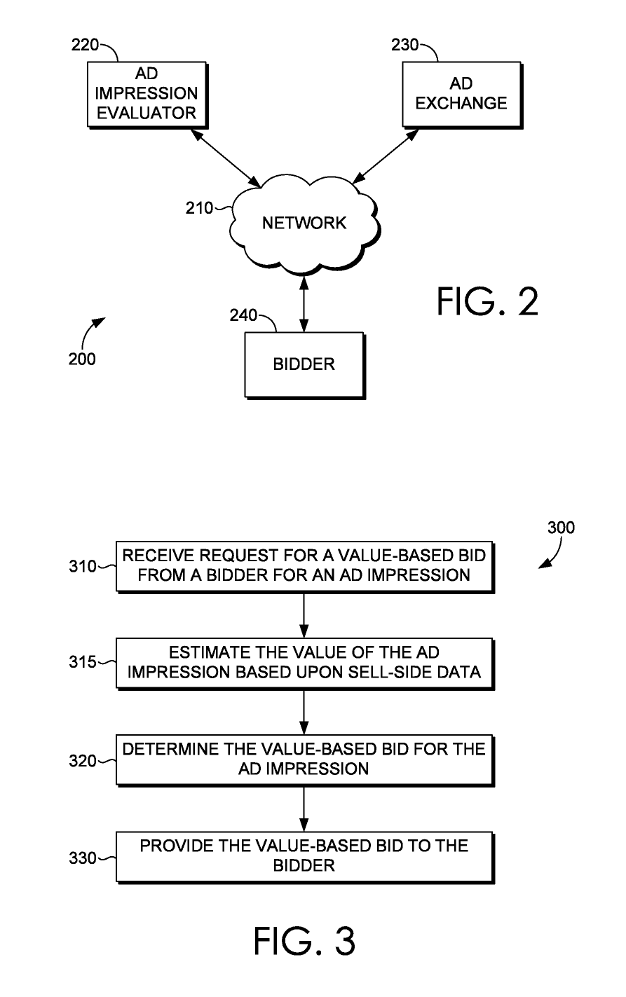

Referring now to FIG. 2, a block diagram is provided illustrating an exemplary network environment 200 for estimating the value of a contextual ad impression. Among other components not shown, the network environment 200 may include an ad exchange 230, a bidder, 240 and an ad impression evaluator 220, all in communication with one another via a network 210. The network 210 may include, without limitation, one or more local area networks (LANs) and/or wide area networks (WANs). Such networks are commonplace in offices, enterprise-wide computer networks, intranets and the Internet. Accordingly, the network 210 is not further described herein.

As illustrated, the ad exchange 230 sends a request for a bid for an ad impression to an ad network or more generally a bidder, e.g., the bidder 240. The bidder 240 then sends the request for the bid to the ad impression evaluator 220 requesting an estimated value-based bid. The ad impression evaluator 220 estimates the value of an ad impression, determines a value-based bid for the ad impression, and provides the value-based bid to the bidder 240. The bidder 240 may then return the bid to the ad exchange 230.

In accordance with embodiments hereof, the ad impression evaluator 220 estimates the value of an ad impression based upon sell-side data, that is, data relevant to the user and the publisher. Thus, given a contextual ad call impression or block i, the expected revenue is

$$E {y}_{i} = {w}_{i} {\sum }_{k = 1}^{m} {b}_{i , k + 1} {p}_{i , k + 1} , \qquad ( 1 )$$

where wᵢ is the auction winning rate, k indexes m positional ranks contained in the ad impression block, b_{i,k+1} and p_{i,k+1} are the CPC bid and the estimated CTR, respectively, of the ad ranked k+1 via a generalized second-price-auction. The expected payoff is then

$$E {u}_{i} = {w}_{i} ( {\sum }_{k = 1}^{m} {b}_{i , k + 1} {p}_{i , k + 1} - {c}_{i}^{TAC} - {c}_{i}^{CTS} ) - {c}_{i}^{CTB} \qquad ( 2 )$$

where cᵢ^{TAC}, cᵢ^{CTS}, and cᵢ^{CTB} are the TAC, CTS and CTB terms, respectively. The CTB term primarily incurred by bid estimation would sink regardless of winning an auction or not (wᵢ), nor does the CTB term depends upon the CTR (p_{i,k}); hence it is more difficult to justify under a competitive exchange for low-response impression opportunities. A typical value of wᵢ in an open exchange is 10%. The typical value of a p_{i,k}'s of contextual ads is very low, 0.3% for example. A full-fledged valuation would scan hundreds of campaigns for a best match to realize the impression value. The full-fledged scan is costly in terms of cᵢ^{CTB}, while only relying on the sell-side data of the impression (e.g., user and publisher), may already give an accurate enough estimate with a substantially lower cᵢ^{CTB}.

The expected revenue given a won impression is the value of the impression, as shown in Equation 1, excluding the winning probability. In an exemplary embodiment, the ad impression evaluator determines a bid based on the value of the ad impression where the value of the ad impression is based on sell-side data.

In some embodiments, the value of the ad impression is estimated using a predictive model of the general form y=f(x), where y is the value of the ad impression and x is the sell-side data. This is a regression problem involving two stochastic processes: (1) a GSP mechanism, and (2) the click-through thereupon. With economical computation as one design goal, x, is an input vector encoding only the sell-side features of the impression, which are known and unique from the RFB at run time, e.g., the user geolocation, the publisher, a page URL, and a placement location for an advertisement. The k-nearest-neighbor (kNN) regression is used to memorize an aggregated view of history, to implicitly capture the best match with the buy-side data, e.g., advertiser and advertisement.

In regards to the choice to use kNN in embodiments of the present invention, clicking on contextual advertisements is not only a very rare event, with more than 95% of advertisements getting no response; but also a very random event, with about 90% variance of revenue that cannot be explained by any single feature available. It is known that kNN classifier is universally Bayes-consistent under the following sufficient condition: if, n→∞, then k→∞ and k/n→0. Embodiments of the present invention approach this condition by controlling the feature dimensionality. Most features in ad domain are categorical, and embodiments of the present invention use binary encoding, i.e., each value is a dimension. For each feature, values are selected by document frequency and a minority bin is used to hold rare ones. By such feature value selection, embodiments of the present invention ensure a desired overall dimensionality d, and the number of kNN keys is upper-bounded by 2^{d}. Consequently, if n→∞, then k≈n/2^{d}→∞ and k/n=1/2^{d}→0.

Formally, given a dataset of historical impression valuation

$$D = {x}_{i} {y}_{i} \begin{matrix}n \\ i\end{matrix} = 1 ,$$

the offline training involves building a mapping:

$$f \text{:} x \to ( {n}_{x} = {\sum }_{i : {x}_{i} = x} 1 , {s}_{x} = {\sum }_{i : {x}_{i} = x} {y}_{i} ) \qquad ( 3 )$$

where x denotes a point in feature space. In online prediction, given an ad impression x′, the maximum likelihood estimate of the value is given by the first moment

$${y}^{MLE} ← \{ \begin{matrix}{s}_{x} \text{/} {n}_{x} & if {x}^{′} = x , \\ {s}_{z ( x )} \text{/} {n}_{z ( x )} & otherwise .\end{matrix} \qquad ( 4 )$$

Here z(x) is a mapping function from x to an aggregate level z, e.g., the publisher-placement pair n_{z} and s_{z} are accumulated accordingly.

Since kNN is a nonparametric model, it will predict zero for x without any historical clicks. This behavior is desirable when sufficient impressions have been sees. However, at the beginning of launching a model on a new traffic source, e.g., a new page, some form of exploration-verses-exploitation needs to be built-in.

In an embodiment, one way to approach this cold-start problem is to impose a beta prior on y, derived from an aggregated level z naturally available from domain hierarchy and typically with much denser data, as follows:

yₓ˜Beta λy_{z(x)}+1,λ1−y_{z(x)}+1 (5)

where y_{z}=s_{z}/n_{z} and λ is a smoothing factor. The MAP estimate of the value of the impression x is

$${y}_{x}^{MAP} ← \frac{{s}_{x} + λ {y}_{z ( x )}}{{n}_{x} + λ} \qquad ( 6 )$$

The Bayesian interpretation is that we have a priori observed λy_{z(x)} revenue from λ impressions with feature vector x before we see any real x. λ controls the smoothing stretch, and we wish to have a reasonably strong smoothing for those x's with zero revenue sₓ=0, while being conservative with the x's with sufficient positive feedbacks, especially for sₓ>>0.

In embodiments, one data-driven approach is λ←mode nₓ: sₓ=0. This ensures that for most zero-revenue x's, the maximum a posteriori estimate is half of its back-off estimate y_{z(x)}.

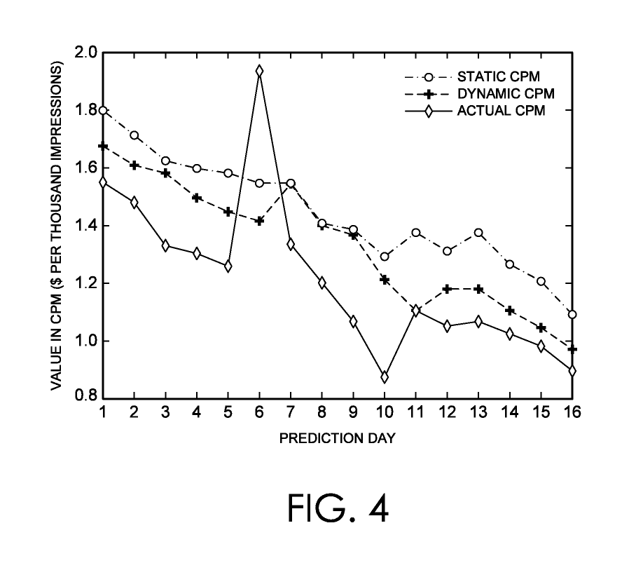

In some instances, the yₓ system may remain static. However, is many instances, the system is dynamic, especially in an exchange environment due to supply changes, i.e., inventory mix, or demand changes, i.e., user and campaign concept drift. In one embodiment, to adapt to the temporal dynamics, an autoregressive model is applied to decay the importance of old data, as follows:

$${y}_{x}^{Dyn} ← \frac{{\sum }_{t = 1}^{T} {s}_{x}^{t} + λ {y}_{z ( x )}^{t} exp γ t}{{\sum }_{t = 1}^{T} {n}_{x}^{t} + λ exp γ t} \qquad ( 7 )$$

where t indexes 1:T training days, γ is an exponential decay parameter fitted into the latest training day T using lease squares and updated daily. The existence of temporal dynamics and the effectiveness of this approach are quite evidence empirically, as shown in FIG. 4.

As explained above, typical approaches to estimating the valuation of an ad impression involve a full-fledged valuation model based on Bayesian profit regression. This approach involves the scanning of hundreds of campaigns for a best match to realize the impression value. Such approaches are costly in terms of the CTB. In embodiments of the present invention, the use of sell-side data and not buy-side data, provides a sufficiently accurate value-based bid in a cost-efficient manner.

As can be understood, embodiments of the present invention provide systems and methods for estimating the value of a contextual ad impression. The present invention has been described in relation to particular embodiments, which are intended to in all respects be illustrative rather than restrictive. Alternative embodiments will become apparent to those of ordinary skill in the art to which the present invention pertains without departing from its scope. While the invention is susceptible to various modifications and alternative constructions, certain illustrated embodiments thereof are shown in the drawings and have been described in detail. It should be understood, however, that there is no intention to limit the invention to the specific forms disclosed, but on the contrary, the intention is to cover all modifications, alternative constructions, and equivalents failing within the spirit and scope of the invention.

It will be understood by those of ordinary skill in the art that the order of steps described in the present invention are not meant to limit the scope of the present invention in any way and, in fact, the steps may occur in a variety of different sequences within embodiments hereof. Any and all such variations, and any combination thereof, are contemplated to be within the scope of embodiments of the present invention.

The invention claimed is:

1. One or more computer-readable storage media having computer-executable instructions embodied thereon that, when executed, perform a method of estimating value of ad impressions, the method comprising:
receiving a request for a value-based bid for an ad impression from a bidder;
estimating the value of the ad impression based upon sell-side data;
determining the value-based bid for the ad impression; and
providing the value-based bid to the bidder.

2. The one or more computer-readable storage media of claim 1, wherein the value of the ad impression is estimated utilizing a predictive model of the general form y=f(x), wherein y is the value of the ad impression and x is the sell-side data.

3. The one or more computer-readable storage media of claim 2, wherein the predictive model comprises a k-nearest-neighbor (kNN) regression.

4. The one or more computer-readable storage media of claim 3, wherein the predictive model further comprises hierarchical smoothing.

5. The one or more computer-readable storage media of claim 1, wherein the sell-side data comprises a user geolocation.

6. The one or more computer-readable storage media of claim 1, wherein the sell-side data comprises a user identification.

7. The one or more computer-readable storage media of claim 1, wherein the sell-side data comprises a site domain associated with a publisher.

8. The one or more computer-readable storage media of claim 1, wherein the sell-side data comprises a publisher page Uniform Resource Locator.

9. The one or more computer-readable storage media of claim 1, wherein the sell-side data comprises a placement location for the ad.

10. A method for estimating the value of an ad impression, the method comprising:
receiving a request for a value-based bid for an ad impression from a bidder;
estimating the value of the ad impression based upon sell-side data, wherein the sell-side data comprises at least one of: a user geolocation, a user identification, a site domain associated with a publisher, a publisher page Uniform Resource Locator, and a placement location for the ad;
determining the value-based bid for the ad impression; and
providing the bid to the bidder.

11. The method of claim 10, wherein the value of the ad impression is estimated utilizing a predictive model of the general form y=f(x), wherein y is the value of the ad impression and x is the sell-side data.

12. The method of claim 11, wherein the predictive model comprises a k-nearest-neighbor (kNN) regression.

13. The method of claim 12, wherein the predictive model further comprises an autoregressive model to decay importance of certain data.

14. The method of claim 13, wherein the data decayed comprises at least one of: a date, a quality of a page, a quality of a user, and market place changes.

15. One or more computer-readable storage media having computer-executable instructions embodied thereon that, when executed, perform a method of estimating value of ad impressions, the method comprising:
receiving a request for a value-based bid for an ad impression from a bidder;
estimating the value of the ad impression based upon sell-side data, wherein the value of the ad impression is estimated utilizing a predictive model of the general form y=f(x), wherein y is the value of the ad impression and x is the sell-side data, and wherein the predictive model comprises a k-nearest-neighbor (kNN) regression, hierarchical smoothing and an autoregressive model to decay importance of certain data;
determining the value-based bid for the ad impression; and
providing the value-based bid to the bidder.

16. The one or more computer-readable storage media of claim 15, wherein the data decayed comprises at least one of: a date, a quality of a page, a quality of a user, and market place changes.

17. The one or more computer-readable storage media of claim 15, wherein the sell-side data comprises a user geolocation.

18. The one or more computer-readable storage media of claim 15, wherein the sell-side data comprises a user identification.

19. The one or more computer-readable storage media of claim 15, wherein the sell-side data comprises a site domain associated with a publisher.

20. The one or more computer-readable storage media of claim 15, wherein the sell-side data comprises a page Uniform Resource Locator.
